(19) United States
(12) Patent Application Publication
(10) Pub. No.: US 2008/0301815 A1
(43) Pub. Date: Dec. 4, 2008

(54) Detecting Unauthorized Changes to Printed Documents

(75) Inventors: Kristin E. Lauter, La Jolla, CA (US); Denis X. Charles, Bellevue, WA (US); Kamal Jain, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/756,599

(22) Filed: May 31, 2007

(51) Int. Cl. G06F 7/04

(52) U.S. Cl. 726/26

(57) ABSTRACT

Systems and methods to detect unauthorized changes to a printed document are described. In one aspect, a digital signature of original content associated with electronic document is embedded into the original content to create a content signed document. The systems and methods use the embedded digital signature to automatically determine whether text-based content associated with a printout of the content signed document was changed from the original content associated with the electronic document.

### BACKGROUND

Paper documents are notoriously susceptible to unauthorized or malicious changes that are undetectable to the human eye. Unless a person can verify that no changes to a paper document's original content have been made to the paper document, it may be inappropriate to trust content of the paper document.

### SUMMARY

Systems and methods to detect unauthorized changes to a printed document are described. In one aspect, a digital signature of original content associated with the electronic document is created using a public-key cryptographic scheme. The digital signature is embedded into the original content to create a content signed document. The systems and methods use the embedded digital signature to automatically determine, and notify a user, whether the text-based content associated with a printout of the content signed document was changed from the original content associated with the electronic document. For example, in one implementation, the systems and methods extract the embedded digital signature from a captured digital image of the printout, resulting in a digital image that is independent of the embedded digital signature. The signature is then verified against the optically recognized text-based content remaining in the digital image. If the signature on the content is valid, then the user is notified that the text-based content of the printout was not altered from the original content associated with the electronic document. Otherwise, the user is notified that the text-based content associated with the printout has been modified from the original content.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows an exemplary system to detect unauthorized changes to printed documents, according to one embodiment.

FIG. 2 shows an exemplary procedure to detect unauthorized changes to a printed paper document, wherein the changes do not reflect original content of a digitally signed electronic document, according to one embodiment.

FIG. 3 shows another exemplary procedure to detect unauthorized changes to a printed paper document, wherein the changes do not reflect original content of a digitally signed electronic document, according to one embodiment.

FIG. 4 shows further exemplary operations of the procedure of FIG. 3 to detect unauthorized (e.g., malicious) changes to a printed paper document, according to one embodiment.

### DETAILED DESCRIPTION

### An Exemplary System

Although not required, systems and methods to detect unauthorized changes in printed documents are described in the general context of computer-executable instructions executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

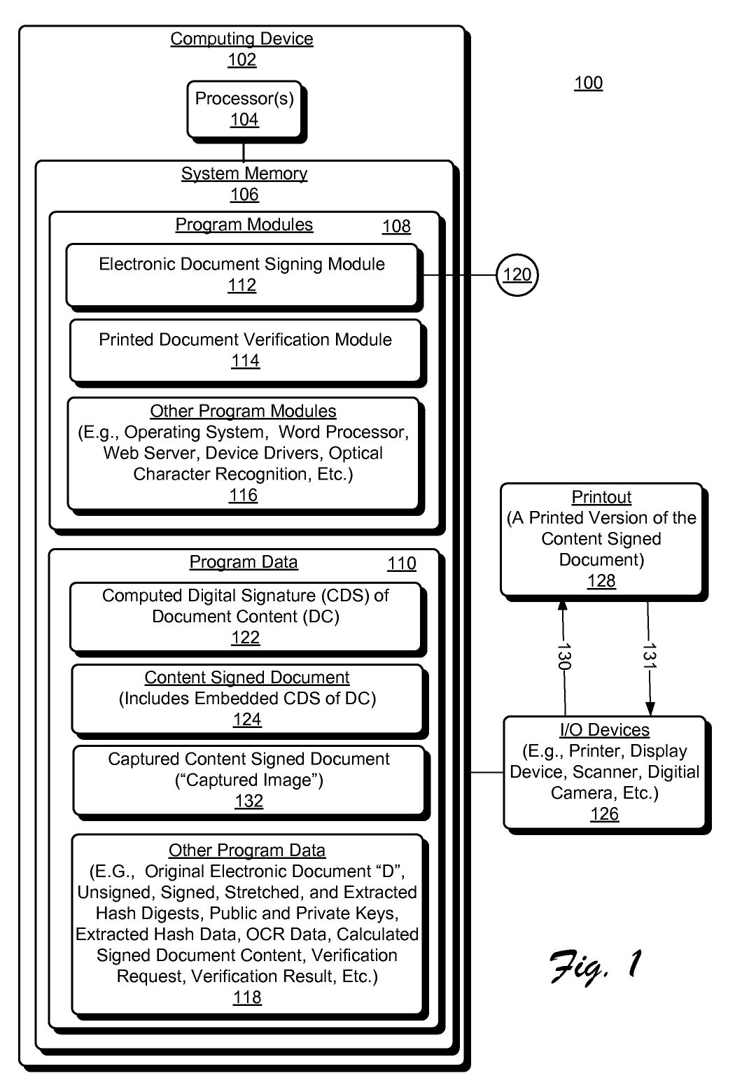

FIG. 1 shows an exemplary system 100 to detect unauthorized changes to a printed document, according to one embodiment. In this implementation, system 100 includes computing device 102. Computing device 102 represents, for example a general purpose computing device, a server, a laptop, a mobile computing device, and/or so on, that accepts information in digital or similar form and manipulates it for a specific result based upon a sequence of instructions. To this end, computing device 102 includes one or more processors 104 coupled to a respective tangible computer-readable storage medium such as a system memory 106. System memory includes, for example, volatile random access memory (e.g., RAM) and non-volatile read-only memory (e.g., ROM, flash memory, etc.). Such a processor may be a microprocessor, microcomputer, microcontroller, digital signal processor, etc. The system memory includes computer-program modules 108 (“program modules”) comprising computer-program instructions executable by the one or more processors and program data 110 that is generated and/or used by respective ones of the program modules 108.

In this implementation, for example, program modules 108 include electronic document signing module 112, printed document verification module 114 and “other program modules” 116 such as an Operating System (OS) to provide a runtime environment, device drivers, an optical character recognition (OCR) application, and/or other applications. Operations implemented by electronic document signing (EDS) module 112 and printed document verification module 114 provide a user with printed document content authenticity verification assurances. Such content authenticity verification indicates to a user whether printed text-based document content purported to represent content of an original electronic document D has been modified from the original (i.e., the printed content no longer reflects content of the original electronic document D). If changes from original content of D are detected in the printed document, such changes are considered unauthorized and potentially malicious because such changes do not mirror original content of the electronic document D. For purposes of exemplary illustration, such an original electronic document D is shown as a respective portion of “other program data” 118. In one implementation, the original electronic document D is generated by an author using a word processor.

To provide printed document content authenticity verification to a user, a document author (or other authorized user) interfaces with EDS module 112 to digitally sign content of the electronic document D. In one implementation, the interface is via a program module 108 interfacing with an Application Programming Interface (API) 120 exposed by EDS module 112. In one implementation, for example, such a program module is a word processor application. To this end, EDS module 112 applies a collision resistant hash function h to D to compute a (unsigned) hash digest h(D) that is k bits long. Although any of multiple known collision resistant hash functions can be used, in this implementation, a standard hash function such as SHA-1 may be used. EDS module 112 then uses one of multiple possible known public-key signature schemes to sign the hash digest using the document author's (or a different authorized entity's) private key to compute s(h(D)), representing a first signed hash digest. The particular public-key signature scheme used to sign the hash digest is arbitrary, and can be one of many possible known public-key cryptographic signature schemes. For purposes of exemplary illustration, such unsigned and signed hash digest are shown as respective portions of “other program data” 118.

EDS module 112 stretches/enlarges the first signed hash digest using one of multiple possible known error correcting codes E to generate stretched hash data. An error-correcting code E adds redundancy to the original bits of the signature, so that errors may be corrected if the scanned (optically recognized) content of the signature contains errors. This reduces false negatives, and is especially useful if the signature is embedded in the document in the form of a bar code or other image-processing technique, which is prone to scanning errors from a low-resolution scanning device. A k-error-correcting code allows one to read a bit string which has at most k-errors (0 flipped to 1 or 1 flipped to 0) and reconstructs the original string from the modified string. Given the encoding, E, of the signature, system 100 first decodes to obtain the signature and then performs verification, as described. In one implementation, exemplary such error correcting codes include, for example, Reed-Solomon codes, LDPC codes, Golay codes, etc. Hash data σ=E(s·h(D)) represents a first computed digital signature 122 of document D content. EDS module 112 embeds/inserts/blends the first computed digital signature of D into D to generate content signed document (CSD) 124. In one implementation, digital signature 122 is embedded into the background of D as lightly shaded boxes or other geometries such that readability of the document is not compromised. For example, in one implementation, the background comprises portions of the electronic document that substantially surround text and/or images in the electronic document. Techniques to code information in lightly shaded boxes or other geometries are known.

For example, in one and two dimensional barcodes, thickness and spacing between lines provides coding for information. In one implementation, EDS module 112 embeds first computed digital signature 122 in a different grayscale region than document text so that intensity information can be used to separate the embedded signature from the text. In another implementation, signature 122 is imprinted on the margins (e.g., side(s), bottom, and/or top) of D.

Using a printer, shown as respective one of I/O devices 126, a user generates a printed version (i.e., printout 128) of the content signed that document 124. For purposes of exemplary illustration, the operational flow of generating printout 128 from a printer I/O device (a respective I/O device 126) is shown with directional arrow 130.

To verify authenticity of content associated with a printed content signed document 126, a user captures an electronic version of the printed content signed document (i.e., print out 128). The data flow associated with this operation is shown as directional arrow 131. A captured electronic version of printout 128 is shown in FIG. 1 as captured content signed a document 132 (hereinafter simply referred to as “captured image 132”). Captured image 132 includes a visible representation of the embedded hash data σ=E(s·h(D)) (e.g., background shading, etc.). In one implementation, the user interfaces with an electronic image scanning device to scan printout 128, and thereby, generate captured image 132. In another implementation, captured image 132 is generated by taking a digital photograph (e.g., with a digital camera, etc.) of printout 128. For purposes of exemplary illustration, such an electronic image scanning device, digital camera, etc., is shown as a respective I/O device 126.

A user interfaces with printed document verification (“PDV”) module 114 to evaluate the captured image 132, and thereby, determine whether changes were made to the printout 128 from which captured image 132 was generated. Specifically, PDV module 114 identifies and separates the encoded, signed hash data σ, which was embedded into contents on document 124, from captured image 132. This extraction operation results in extracted hash data and the captured image 132 without the embedded hash data σ. For purposes of exemplary illustration, such extracted hash data is shown as respective portion of “other program data” 118.

PVM module 114 electronically recognizes and analyzes the remaining content of the captured image 132 (i.e., “remaining content” that does not include embedded hash data σ) using optical character recognition (OCR) operations to generate corresponding text information T (shown as “OCR data” in a respective portion of “other program data” 118). Such an OCR application is shown as a particular “other program module” 116. In one implementation, PVM module 114 automatically invokes the OCR application subsequent to extracting embedded hash data from captured image 132.

PVM module 114 applies a collision resistant hash function h to T, the OCR data, resulting in a computed/extracted hash digest h(T). (The hash function is the same collision resistance hash function previously applied to D). The extracted hash digest is shown as respective portion of “other program data” 118. PVM module 114 decodes the error correcting code from the extracted hash data σ to calculate the signature on the hashed document content, s·h(D). Such calculated signed hash of document content is shown as respective portion of “other program data” 118. To determine whether content of the printed document was modified, the PVM 114 (a document content cryptosystem) verifies the signature s·h(D) against the hash digest h(T) using a known public-key cryptographic signature scheme to verify signatures for the implemented public-key signature scheme. In this implementation, the public-key cryptographic signature scheme is the same scheme used to generate the content signed document 124, as described above. If s·h(D) is a valid signature on the hash digest h(T), PVM 114 notifies the user that authenticity of the content T is verified. Otherwise, PVM 114 notifies the user that content T does not represent the authentic content of the author. There are multiple known techniques to provide such notifications (e.g., a message presented on a display device, audio, etc.).

In view of the above, an entity that changes content of a printed version of the content signed document 124, wherein the entity is not the author of content signed document 124, cannot reproduce the signature that is needed for the above described printed-paper content verification operation to succeed. This is because the entity does not have the document preparer's private key. Thus, this scheme will never declare a doctored document as “genuine”.

It is possible that the above described operations to detect changes to a printed document (printout 128) may declare an un-doctored printout 128 as “doctored” because of errors introduced, for example, by the scanning process, or by other sources (e.g., ink or other material obfuscating original document text, etc.), and thereby, produce a “false-negative”. To address this latter scenario, suppose the error correcting code E can be used to correct k errors. If no more than k errors occurred in the scanning, hash data σ is perfectly reconstructed. Accordingly, in one implementation, a robust error correcting code is used to decrease the number of false-negatives. Additionally, errors generated via the OCR operations can be minimized, for example, by showing a text version of the document to the verifier, who can manually correct errors committed by the OCR. This correction process can be expedited if the OCR highlights regions of low confidence recognition of letters.

### Exemplary Procedures

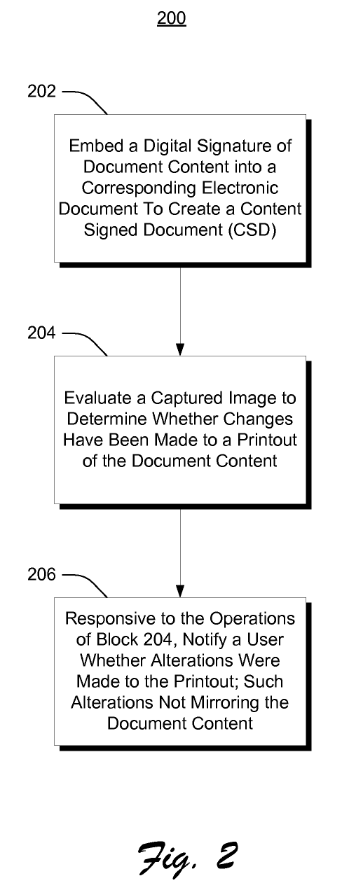

FIG. 2 shows an exemplary procedure 200 to detect malicious changes to a printed paper document, according to one embodiment. For purposes of exemplary illustration, the operations of procedure 200 are described with respect to the above described aspects of FIG. 1. The leftmost numeral of a reference number indicates the figure in which the component or operation was/is first introduced. In one implementation, the operations of procedure 200 are implemented by respective ones of program modules 108 (FIG. 1). Operations at block 202 embed a digital signature of document content into a corresponding electronic document to create a content signed document. In one implementation, for example, electronic document signed module 112 (FIG. 1) embeds a digital signature of an electronic document's content into the electronic document to create a content signed document 124.

Operations of block 204 evaluate a captured image to determine whether changes have been made to a printout of the content signed document. Specifically, and in one implementation, printed document verification module (PVM) 114 evaluates captured image 132 of content signed document 124 to determine whether changes have been made to content of printout 128, wherein captured image 132 is an electronic version of printout 128. Operations at block 206, responsive to the operations of block 204, notify user whether alterations were made to a printout. Such alterations indicate that the printout does not mirror/repeat/reflect/reproduce content if an original electronic document D. For example, and in one implementation, PVM module 114 notifies the user whether alterations were or were not made to printout 128, wherein any such alterations are not representative of the original content of content signed document 124 (a cryptographically signed a version of the original electronic document D). In this implementation, changes made before the content is signed (block 202) will not be detected. However, changes implemented after the content is signed will be detected.

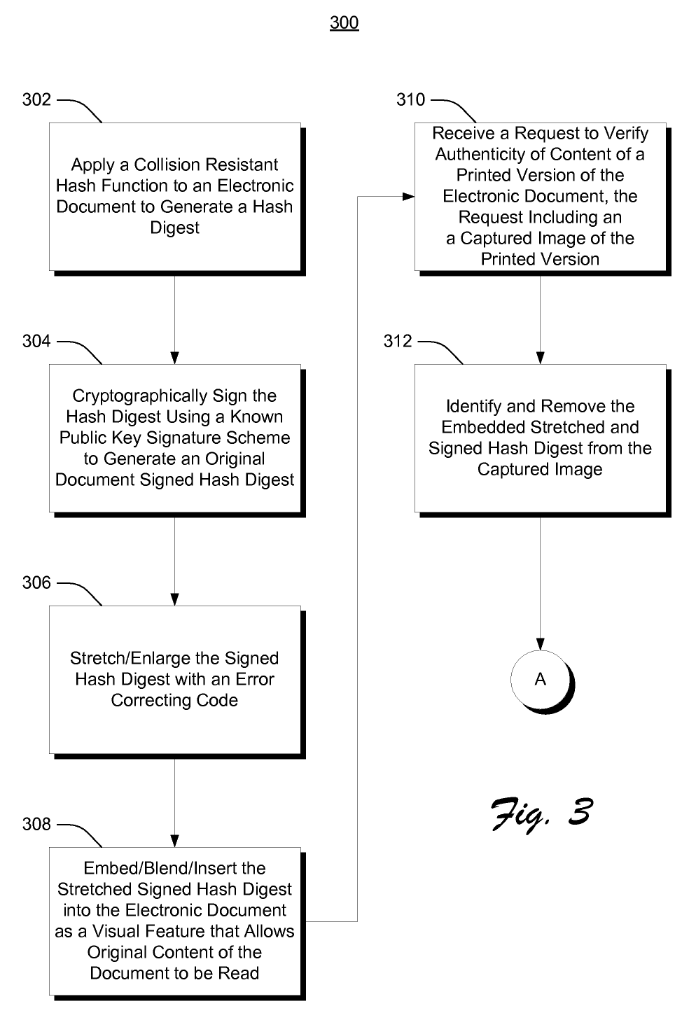

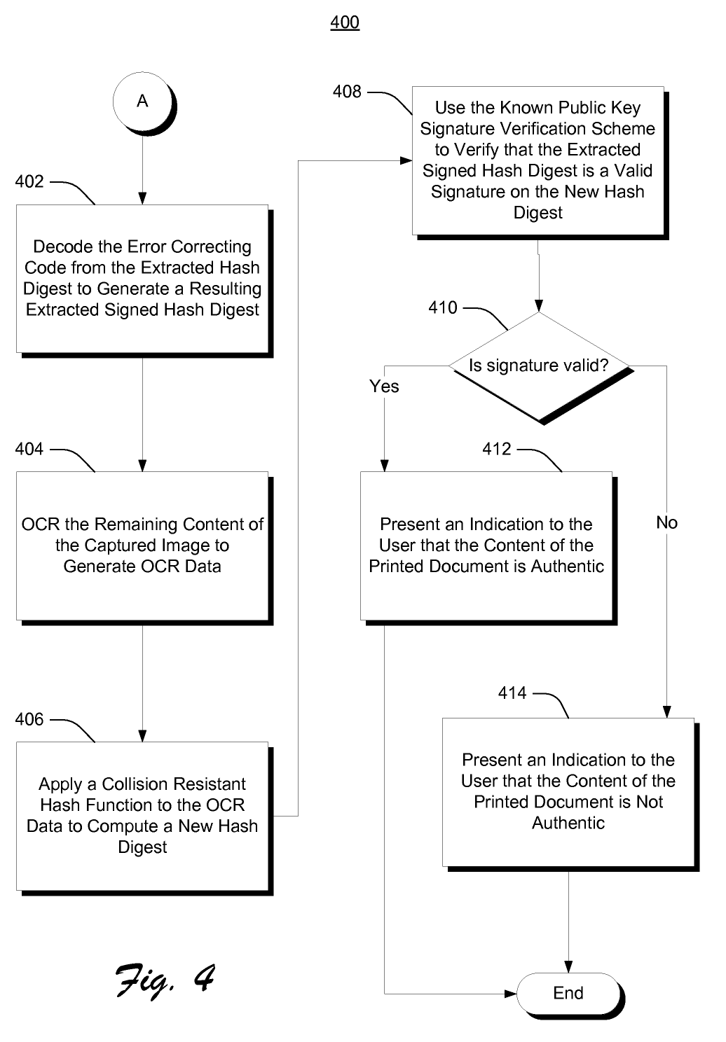

FIG. 3 shows an exemplary procedure 300 to detect malicious changes to a printed paper document, according to one embodiment. For purposes of exemplary illustration, the operations of procedure 300 are described with respect to the above described aspects of FIG. 1. The leftmost numeral of a reference number indicates the figure in which the component or operation was/is first introduced. In one implementation, the operations of procedure 300 are implemented by respective ones of program modules 108 (FIG. 1). Operations at block 302 apply a collision resistant hash function to an electronic document D to generate a hash digest h(D). Operations at block 304 cryptographically sign the hash digest h(D) using a known public key signature scheme to generate an original document signed hash digest (e.g., computed digital signature of document content 122 in FIG. 1) Operations at block 306 add redundancy to the signed hash digest with an error correcting code. Operations at block 308 embed the stretched signed hash digest into the electronic document as visual/visible feature(s). This creates a content signed document 124. The visible features are embedded in the content signed document 124 are such that a user can still read the original content of the document (original content is content that was present before embedding of the stretched and signed hash digest information). Operations of block 310 receive a request to verify authenticity of content of a printed version (printout 128) of the content signed document 124. In this implementation, the request includes, or otherwise identifies, a captured image (an electronic image) 132 of the printout 128. Operations of procedure 300 continue at on-page reference “A”, as shown on FIG. 4.

FIG. 4 shows further exemplary operations of procedure 300 of FIG. 3 to detect malicious changes to a printed paper document, according to one embodiment. Operations at block 402 decode the error correcting code from the extracted hash digest to generate a resulting extracted signed hash digest. Operations of block 404 implement optical character recognition (OCR) on the remaining content of the captured image to generate OCR data. Operations of block 406 apply a collision resistant hash function to the OCR data to compute a new hash digest. Operations of block 408 use a known public key signature verification scheme (i.e., the public key signature scheme used to generate the signed hash digest 122) to verify whether the extracted signed hash is a valid signature on the new hash digest. Operations of block 410, determine if the signature on a hash digest is valid. If verification of the signature on the hash digest was determined valid (please see the operations of block 408), operations of block 412 present an indication to the user that the content of the printed document is authentic. Otherwise, if the signature on the hash digest was not valid (please see the operations of block 408), operations of block 414 present an indication to the user that content of the printed document is not authentic.

### Alternate Embodiments

In this implementation, electronic document signing module 112 and printed document verification module 114 have been described as being implemented on a single computing device 102. In another implementation, however, respective ones of modules 112 and 114 are implemented on different respective computing devices independent of whether the different computing devices are coupled to one another over a communications network. Accordingly, although operations associated with generating content signed document 124 have been described as being implemented on a same single computing device 102 used to detect if any changes were made to a printout (a printed version) 128 of an original electronic document D, these respective operations can be implemented on different computing devices. In this alternate implementation, such different computing devices have characteristics (processor(s), system memory, etc.) of computing device 102 independent of any program module(s) 108 and I/O devices 126 not used to perform the desired functions to detect changes to a printed document.

### CONCLUSION

Although detecting unauthorized changes to printed documents has been described in language specific to structural features and/or methodological operations or actions, it is understood that the implementations defined in the appended claims are not necessarily limited to the specific features or actions described. Rather, the specific features and operations discussed above are disclosed as exemplary forms of implementing the following claimed subject matter.

1. A method at least partially implemented by a computing device, the method comprising:
embedding a digital signature of document content into a corresponding electronic document to create a content signed document; and
wherein electronic information associated with a printout of the content signed document can be digitally evaluated to indicate to a user whether changes have been made to the printout.

2. The method of claim 1, wherein embedding the digital signature further comprises:
applying a collision resistant hash function to the document content to generate a hash digest;
cryptographically signing the hash digest using a public key signature scheme to create an original document signed hash digest; and
wherein information associated with the original document signed hash digest is embedded into the electronic document to create the content signed document.

3. The method of claim 2, wherein the information is embedded into a background portion of the electronic document, the information representing a signature portion of the content signed document and not the entire content signed document.

4. The method of claim 2, wherein the information is embedded as shaded boxes or other geometries into a background portion of the electronic document.

5. The method of claim 2, wherein the method further comprises:
enlarging the original document signed hash digest with an error correcting code to generate a stretched signed hash digest; and
blending the stretched signed hash digest into the electronic document to create the content signed document.

6. The method of claim 1, wherein the method further comprises:
evaluating the electronic information to determine whether changes have been made to the printout; and
responsive to evaluating the electronic information, notifying the user whether alterations were made to the printout, wherein the alterations do not reflect an accurate reproduction of the document content.

7. The method of claim 6, wherein the electronic information is a result of optical character recognition of a captured digital image of the printout.

8. The method of claim 6, wherein evaluating the electronic information further comprises:
removing the encoded digital signature from the electronic information, the encoded digital signature being a stretched signed hash digest generated from an original document signed hash digest that has been enlarged with an error correcting code;
decoding the encoded digital signature to obtain the digital signature;
recognizing remaining text-based content of the electronic information to generate recognized content;
applying a collision resistant hash function to the recognized data to compute a hash digest for comparison to an original hash digest; and
verifying that the digital signature is valid against the computed hash digest.

9. The method of claim 8, wherein the recognized content is provided to a user for editing with a word processor prior to operations of the applying and the verifying.

10. A computer-readable data storage medium comprising computer-program instructions executable by a processor, the computer-program instructions, when executed by the processor, for performing operations comprising:
extracting a encoded digital signature from a digital image of a printed document;
decoding the encoded digital signature to obtain the signature;
generating, using the collision resistant hash function, a hash digest from electronically recognized content associated with the digital image, the electronically recognized content being recognized independent of the digital signature;
verifying that the digital signature is valid on the hash digest;
if the signature is valid, indicating to the user that no unauthorized changes have been made to the printed document; and
if the signature is not valid, indicating to the user that unauthorized changes have been made to the printed document.

11. The computer-readable data storage medium of claim 10, wherein the printed document is based on an electronic content signed document, the electronic content signed document comprising an embedded digital signature of text-based content of an unsigned original electronic document.

12. The computer-readable data storage medium of claim 10, wherein the method further comprises creating the electronically recognized content via optical character recognition operations.

13. The computer-readable data storage medium of claim 10, wherein decoding the digital signature further comprises decoding the digital signature using an error correcting code and a public-key cryptographic signature scheme.

14. The computer-readable data storage medium of claim 10, wherein extracting the digital signature further comprises evaluating one or more background visual features of the digital image to identify a digital signature.

15. The computer-readable data storage medium of claim 14, wherein the background visual features are shaded boxes or other geometries.

16. A computing system comprising:
a processor; and
a memory coupled to the processor, the memory comprising computer-program instructions executable by the processor for performing operations comprising:
embedding a digital signature of document content into a corresponding electronic document to create a content signed document;
evaluating, using an extracted version of the digital signature, a captured image generated from a printout of the content signed document to determine whether changes have been made to content of the printout; and
responsive to evaluating the captured image, notifying a user of any unauthorized alterations to the content of the document.

17. The computing device of claim 16, wherein embedding the digital signature further comprises:
applying a collision resistant hash function to the document content to generate a first hash digest;
cryptographically signing the first hash digest using a public-key signature scheme to generate a signed hash digest;
stretch the signed hash digest with an error correcting code to generate a stretched signed hash digest; and
blend the stretched signed hash digest into the electronic document to generate the content signed document.

18. The computing device of claim 16, wherein the method further comprises receiving a request to verify authenticity of content of a printed version of the content signed document, the printed version being the printout.

19. The computing device of claim 16, wherein evaluating the captured image further comprises:
removing the digital signature from the content signed document, the digital signature being an error correcting code stretched version an original document signed hash digest, removal of the digital signature resulting in an electronic document independent of the digital signature;
decoding the error correcting code stretched version to generate an extracted signed hash digest;
optically recognizing remaining text-based features in the electronic document to generate recognized content;
applying a collision resistant hash function to the recognized data to compute a new hash digest; and
determining, using a public-key cryptographic scheme, whether the extracted hash digest is the same as the new hash digest; and
wherein the determining indicates to a user whether content of the printout mirrors the document content of the corresponding electronic document.

20. The computing device of claim 19, wherein the method further comprises:
if the first hash digest matches the new hash digest, notifying the user that text-based content of the printout matches the document content of the corresponding electronic document; and
if the first hash digest does not match the new hash digest, indicating to the user that the text-based content does not match the document content of the corresponding electronic document.
